(19) United States
(12) Patent Application Publication
(10) Pub. No.: US 2010/0019204 A1
(43) Pub. Date: Jan. 28, 2010

(54) SURFACE TREATMENT METHOD FOR NANOPARTICLES

(75) Inventor: Markus Haase, Osnabrueck (DE)

Correspondence Address: SCULLY SCOTT MURPHY & PRESSER, PC, 400 GARDEN CITY PLAZA, SUITE 300, GARDEN CITY, NY, 11530, US

(73) Assignee: CENTRUM FUER ANGEWANDTE NANOTECHNOLOGIE (CAN) GMBH, Hamburg (DE)

(21) Appl. No.: 12/520,640

(22) PCT Filed: Dec. 20, 2007
(86) PCT No.: PCT/EP2007/064345

§ 371 Date: Aug. 5, 2009

(30) Foreign Application Priority Data
Dec. 20, 2006 (EP) 06026440.5

(51) Int. Cl. C09K 11/78

(52) U.S. Cl. 252/301.36

(57) ABSTRACT

The present invention relates to a surface treatment method for nanoparticles. The present invention particularly relates to a surface treatment method for nanoparticles, which increases the dispersion ability of the nanoparticles in a solvent, and in which a mixture made of a polyvalent acid and a nitrogen-containing base, such as an amine, or a salt of a polyvalent acid and a nitrogen-containing base, such as ammonium salt, or also a corresponding betaine, is used. The present invention also relates to surface-modified nanoparticles, which can be obtained by the inventive method.

### FIELD OF THE INVENTION

The present invention relates to a surface treatment method for nanoparticles. In particular, the present invention relates to a surface treatment method for nanoparticles by means of which the dispersibility of the nanoparticles in a solvent is increased and in which a mixture of a polybasic acid and a nitrogen-containing base, for example, an amine, or a salt from a polybasic acid and a nitrogen-containing base, such as an ammonium salt or a suitable betaine is used. The present invention also relates to surface-modified nanoparticles which are obtainable with the method according to the invention.

### PRIOR ART

A large number of methods for producing nanoparticles is known. In this regard, the term “nanoparticles” relates to particles with a size of less than 1 μm. Nanoparticles of this type have a broad spectrum of uses, for example in the production of inks, including security printing inks, in the surface modification of metallic or nonmetallic substrates, as phosphorescent or fluorescent materials, as markers for biological molecules, as polymer fillers, as X-ray contrast media, etc.

The synthesis pathways for production of such nanoparticles are known to persons skilled in the art. Examples of publications are WO 02/20696 A1, EP 1 473 347 A1 and EP 1 473 348 A1. The method according to the invention is also applicable to the nanoparticles described by von Haase et al. (Journal of Physical Chemistry B, 104, 2824-2828).

Nanoparticles, for example, in the size range between 2 nm and 20 nm can be made in large quantities nowadays by reaction in high boiling solvents. The dispersibility of such, essentially inorganic and/or crystalline particles, which is generally good, is considerably influenced by the organic molecules binding to the surface of the nanoparticles. These molecules usually contain one or more, preferably polar, chemical groups which bind to the surface of the nanoparticles. This binding can arise through ionic interactions and/or covalent bonding to the particle surface.

Apart from the component interacting with the particle surface, these organic molecules generally contain at least one further component, the polarity of which determines the dispersibility in any given solvent. In some cases, this may also be the same component as the component interacting with the nanoparticle surface. For example, long alkane chains lead to increased solubility (i.e. dispersibility) of the particles in weakly polar or non-polar solvents such as hexane, toluene or chloroform.

As a rule, the groups interacting with the surface are added during synthesis of the nanoparticles to control the particle growth (and thereby the particle size) and to increase the solubility (dispersibility) of the particles in the reaction medium. Furthermore, they also prevent the congregation of particles, that is, the formation of agglomerations.

However, so that the particles can become attached during the growth process in solution by reaction with the added reagent material, the organic molecules must be at least partially displaceable from the surface under synthesis conditions (e.g. reaction temperature). Therefore the strength of binding of the organic molecules to the surface must not exceed a predetermined maximum value, since otherwise, they would not be able to be displaced by particle components that are necessary for the growth of the particles.

The nanoparticles made in this way therefore have organic molecules on their surface which ensure their dispersibility in the reaction medium. From the industrial standpoint, it is desirable, however, to isolate the nanoparticles after synthesis in order to be able to store them more easily. When isolating the nanoparticles, a washing or separating step is usually carried out. However, this can lead to the problem that a proportion of the organic molecules adhering to the surface are removed from the surface of the nanoparticles in the washing and cleaning steps following synthesis. This reduces the dispersibility of the particles. A method is therefore needed which possibly comprises a washing and/or cleaning step and improves the dispersibility or solubility of nanoparticles of this type following isolation.

It should also be ensured that the organic molecules binding to the surface of the nanoparticles during and after synthesis are adapted to the reaction medium. For example, with highly non-polar reaction media, organic molecules with non-polar groups are used. However, it is desirable, for various applications, to obtain a dispersion in which the nanoparticles are dispersed in a different solvent from the reaction medium, with properties (e.g. polarity) that are possibly different from the reaction medium. What is sought, therefore, is the most general possible method with which the dispersibility of the particles in a selected solvent can be increased. The solvent should not be limited to one of the components used in the reaction medium, but should be as freely selectable as possible, since the polarity of the solvent is mainly determined by the type of application.

### SUMMARY OF THE INVENTION

The problems addressed above are solved with the method according to the invention for the surface treatment of nanoparticles. It is an object of the present invention to provide a surface treatment method by means of which the dispersibility of the treated nanoparticles is improved. It is a particular object of the present invention to increase the dispersibility of nanoparticles which, following their synthesis, are isolated and possibly subjected to a washing step.

The invention therefore relates to a surface treatment method for improving the dispersibility of nanoparticles that have been isolated following synthesis and possibly, after isolation, subjected to one or more washing steps, wherein the method comprises treatment of the nanoparticles with (i) one or more organic nitrogen-containing base(s) and one or more polybasic acid(s) or (ii) a salt of one or more organic nitrogen-containing bases and one or more polybasic acids, or (iii) a betaine which contains within the molecule one or more nitrogen-containing basic group(s) and one or more polybasic acid group(s).

The expressions “polybasic acid groups” or “polybasic acid” as used herein denote an acid or an acid group which, on complete dissociation, can release 2 or more protons which, in the non-dissociated condition (e.g. at pH 0) are bound to an oxygen atom of the acid or acid group.

Reference is made below to the combination of nitrogen-containing base(s) and polybasic acid(s) as “acid/base combination”. This expression covers the combination (i), the salt (ii) and also the betaine (iii), insofar as nothing else results from the association.

### DETAILED DESCRIPTION OF THE INVENTION

The method according to the invention comprises the surface treatment of nanoparticles with a mixture of a nitrogen-containing base and a polybasic acid or a salt thereof following synthesis of the nanoparticles and their separation from the reaction medium, wherein following the separation, a washing step is possibly carried out. The method used for separating the nanoparticles following synthesis is not particularly restricted, but centrifuging, filtration and removal of the solvent by evaporation, possibly under negative pressure can, for example, be carried out.

According to the invention, a “washing step” means optional treatment steps which are carried out after isolation of the nanoparticles (e.g. by precipitation) in order to clean the nanoparticles, for example, in order to remove residues of the starting materials or possibly other chemical substances present in the reaction mixture which adhere to the surface of the nanoparticles. The washing steps are carried out with a suitable solvent which is preferably chosen such that the isolated nanoparticles show no, or only slight, solubility therein. In the hydrothermal synthesis of nanoparticles, as described, for example, by M. Haase et al. in “Synthesis and properties of colloidal lanthanide-doped nanocrystals” in Journal of Alloys and Compounds 303-304 (2000) 191-197 or by H. Meyssamy et al. in Advanced Materials 1999, 11, No. 10, pages 840-844, a solvent which is miscible with water is preferably used, for example a water-miscible ether such as THF, a water-miscible ketone such as acetone, or a water-miscible alcohol, such as methanol or ethanol. Solvents which are fully miscible with water in any mixing ratio at 20° C. are considered to be water-miscible. “Hydrothermal synthesis” is considered to be the synthesis of nanoparticles from a suitable cation source and a suitable anion source in water as the sole reaction medium, under pressure (e.g. in an autoclave) and at a raised temperature (preferably higher than 150° C.). In the organic synthesis of nanoparticles, preferably according to WO 02/20696, in a coordinating solvent with a phosphorus or nitrogen atom having a free electron pair, methanol is preferably used for washing. In the synthesis of sulphates according to WO 2004/046035, the same solvents can be used for washing as for the hydrothermal synthesis. If sulphates are synthesised according to WO 2005/105933, it should be noted that the nanoparticles obtained may also be dispersible in methanol and therefore the use of other water-miscible alcohols or the use of a water-miscible ketone or ether is recommended. In the synthesis of vanadates according to WO 2004/06714 or titanium dioxide nanoparticles according to PCT/EP2004/012376 the same water-miscible solvents can be used again as for hydrothermal synthesis.

The nanoparticles which can be used in the method according to the invention are not subject to any particular restrictions. In the context of this invention, the term “nanoparticles” denotes particles with a size (longest axis) of less than 1 μm, preferably less than 300 nm, more preferably between 1 nm and 25 nm, and most preferably between 2 nm and 10 nm. These nanoparticles can be made from a material that is essentially homogeneous with regard to their structure. However, it may relate to nanoparticles which are built up from layers such as, for example, the core/shell particles described in EP 1 473 347 and EP 1 473 348. The nanoparticles may be crystalline, partly crystalline or amorphic, wherein crystalline materials are preferred. The form of the nanoparticles is also not subject to any restrictions. In particular, the nanoparticles can be, for example, ellipsoid, spherical, plate-shaped, needle-shaped (length/width≧2, preferably ≧5), cubic, rhombic or irregularly structured.

The nitrogen-containing base is not subject to any particular restrictions. It contains one or more basic nitrogen atoms. In particular, aliphatic, alicyclic and aromatic nitrogen containing bases can be used. The term “base” in this context denotes compounds that are capable, by the uptake of a proton, of forming a cation (e.g. an ammonium ion in the case of an anime). The compounds preferably have a pK_{B} value of between 2 and 6, in particular between 3 and 5 (25° C., aqueous solution).

Primary (NH₂R), secondary (NHRR′) and tertiary (NRR′R″) amines can be cited as representatives of the aliphatic nitrogen-containing bases for use in the inventive method. The groups R, R′ and R″ can be the same or different and denote possibly simple or multiple-substituted aliphatic hydrocarbon groups with up to 20 carbon atoms, each of which can be saturated or unsaturated, wherein the unsaturated hydrocarbon groups contain 1 to 4, preferably 1 or 2 carbon-carbon double bonds. These groups can also be straight-chained or branched. Groups with up to 16 carbon atoms are preferred. Straight-chained or branched alkyl groups are also preferred. Especially preferable are amines with groups R, R′ or R″ with a carbon count of 3-14, and more especially preferable 6-12. Particularly, secondary and tertiary amines and, most particularly, tertiary amines with these groups R, R′ and R″, since they show better compatibility with organic solvents. The total carbon count in the aliphatic nitrogen-containing bases is in the range of 1-60, preferably 6-50, more preferably 8-40 and most preferably 12-36.

Groups that can be used as substituents for the groups R, R′ and R″ are cycloalkyl groups, halogen atoms (F, Cl, Br, I), cyano groups, hydroxyl groups, aromatic groups, such as benzyl or phenyl, which in turn can undergo substitution with one or more of the groups listed here, and also ether groups and ester groups. If they contain carbon atoms, these substituents are included in the carbon counts given above of the groups R, R′ and R″ of the amines or in the overall carbon count.

Two of the groups R, R′ and R″ together can form a ring. It is preferable if the relevant groups R, R′ and R″ together form a 5 to 7-member ring. A cyclohexyl ring is most preferable.

Preferred representatives of the primary amines are propylamine, butylamine, pentylamine, hexylamine, heptylamine, octylamine, nonylamine, decylamine, undecylamine, dodecylamine, tridecylamine and tetradecylamine, wherein hexylamine, heptylamine, octylamine, nonylamine, decylamine, undecylamine and dodecylamine are preferred, and these may possibly undergo substitution.

Preferred representatives of the secondary amines are dipropylamine, dibutylamine, dipentylamine, dihexylamine, diheptylamine, dioctylamine, dinonylamine, didecylamine, diundecylamine, didodecylamine, ditridecylamine and ditetradecylamine, wherein dihexylamine, diheptylamine, dioctylamine, dinonylamine, didecylamine, diundecylamine and didodecylamine are preferred, and these may possibly undergo substitution.

Preferred representatives of the tertiary amines are tripropylamine, tributylamine, tripentylamine, trihexylamine, triheptylamine, trioctylamine, trinonylamine, tridecylamine, triundecylamine, tridodecylamine, tritridecylamine and tritetradecylamine, wherein trihexylamine, triheptylamine, trioctylamine, trinonylamine, tridecylamine, triundecylamine and tridodecylamine are preferred, and these may possibly undergo substitution.

The term “alicyclic nitrogen-containing bases” denotes compounds with, for example, 2 to 30 carbon atoms and containing one or more nitrogen atoms as a component of at least one non-aromatic ring. This ring can also contain heteroatoms such as oxygen or sulphur. The term “alicyclic nitrogen-containing base” also includes compounds with two or more ring systems, which may possibly be condensed, although single ring systems are preferred. The ring system(s) possibly present in addition to the nitrogen-containing ring may be alicyclic or aromatic and they may possibly contain other atoms such as S or O as a component of the ring. Compounds with 3-16 carbon atoms are preferable and compounds with 4-11 carbon atoms are more preferable, wherein compounds with 4-6 carbon atoms are most preferable. These compounds can possibly undergo substitution with one or more substituents as set out above for aliphatic nitrogen-containing bases, wherein this/these possibly present substituent(s) are included in the above carbon count. Preferred representatives of the alicyclic nitrogen-containing bases can be 4, 5, 6, 7 or 8-member ring systems which contain an amine (NH) or imine (═N—) group as a component of the ring. Examples of alicyclic nitrogen-containing bases are piperidine, piperazine, pyrrolidine, pyrazole and morpholine.

The term “aromatic nitrogen-containing base” denotes compounds with 3-30 carbon atoms which contain one or more nitrogen atoms as a component of at least one aromatic ring. This ring can also contain heteroatoms such as oxygen or sulphur. This term also covers compounds with two or more ring systems, which may be condensed, although single ring systems are preferable. The ring system(s) present apart from the nitrogen-containing ring can be alicyclic or aromatic and they can possibly contain other atoms, such as S or O as constituents of the ring. Compounds with 4-15 carbon atoms are preferable and compounds with 5-11 carbon atoms are more preferable. These compounds can possibly undergo substitution with one or more substituents, as set out above for the aliphatic nitrogen-containing bases, wherein the possibly present substituent(s) are included in the above carbon count. Particularly preferred representatives of the aromatic nitrogen-containing bases are 4, 5, 6, 7 and 8-member ring systems. Exemplary representatives of the aromatic nitrogen-containing bases are pyridine, pyrimidine, quinoline, isoquinoline, indole, pyrrole, acridine, pyrazine, quinoxaline, pteridine, purine, imidazole, thiazole and oxazole. Pyridine is particularly preferable.

The polybasic acid to be used in the inventive treatment method in combination with nitrogen-containing bases is not particularly restricted. The acid may release more than one proton and may be an organic acid or a mineral acid. Examples of suitable acids are phosphorus-containing acids such as phosphoric acid, diphosphoric acid, pyrophosphoric acid, polyphosphoric acids, phosphonic acids, diphosphonic acids, polyphosphonic acids, phosphoric acid monoesters and organic phosphoric or phosphonic acids derived from phosphoric acid or phosphonic acid.

The organic phosphorus-containing acids can comprise at least one aliphatic, alicyclic or aromatic organic group which can possibly undergo substitution with, among other things, substituents like those set out above for the substituents of the groups R, R′ and R″ of the aliphatic nitrogen-containing base. The total carbon count of the organic phosphorus-containing acids is preferably not more than 26 and, in particular, not more than 20 per P atom. The substituents that may be present are included in the carbon count.

In the case of organic monophosphonic acids, these can preferably be represented by the following formula (1):

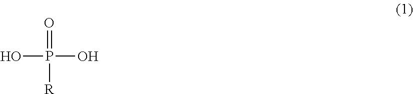

where R can be a straight-chain or branched, saturated or unsaturated hydrocarbon group which preferably contains 1-18, more preferably 2-12 and yet more preferably 3-6 carbon atoms and possibly contains heteroatoms. The group R can also comprise 1-4, preferably 1 or 2 carbon-carbon double bonds. The group R can be aliphatic or aromatic and comprises, for example, a cycloalkyl, cycloalkenyl, alkyl, alkenyl or aryl group. The group R can be unsubstituted or single or multiple substituted. The substituents of R are preferably selected from among the cycloalkyl groups, preferably with 5-7 carbon atoms, more preferably with 6 carbon atoms, halogen atoms (F, Cl, Br, I), cyano groups, carboxy groups, hydroxyl groups and aromatic groups (aryl), such as benzyl or phenyl groups. In the case of aromatic groups R, 1 aromatic ring can be present or a condensed ring system of 2 or 3 rings can be present.

In the group R, one or more secondary carbon atoms (—CH₂—) are replaced with a heteroatom, for example, an oxygen atom (—O—), sulphur atom (—S—) or with a secondary amino group (—NH—). In branched hydrocarbon groups R, one or more tertiary carbon atoms (—CH—) are replaced by an N atom. The total number of heteroatoms in the group R is preferably not more than 6 and more preferably not more than 4 (e.g. 1, 2, or 3). Furthermore, it is preferable that the heteroatoms are not present in the immediate vicinity of the phosphonic acid groups and/or not directly bound to one another. The heteroatoms that may be present are not included in the carbon counts given here.

Examples of preferred organic phosphonic acids include phenyl phosphonic acid and tetradecyl phosphonic acid.

The organic diphosphonic acids can preferably be represented by the following formula (2):

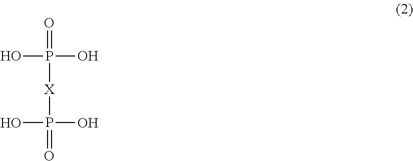

X represents a straight-chain or branched, saturated or unsaturated divalent hydrocarbon group with preferably 1-18, more preferably 2-12 and most preferably 3-6 carbon atoms, wherein X can contain 1-4, preferably 1 or 2 carbon-carbon double bonds. Examples of X include a cycloalkylene, cycloalkenylene, alkylene, alkenylene or arylene group.

X can preferably be obtained from the group R of formula (1), in that by abstraction of an H atom from a carbon atom, a second binding site is available for the second phosphonic acid group. The abstraction of the H atom can also take place at one of the previously named C-containing substituents of the group R. Furthermore, one or more C atoms can be replaced by heteroatoms. The same applies as stated for formula (1).

The phosphonic acid groups can be available at the same carbon atom or different carbon atoms of X, wherein it is preferred that they are present on the same carbon atom.

Examples of preferred diphosphonic acids contain 1-hydroxyethane-1,1-diphosphonic acid or morpholinomethane diphosphonic acid.

Organic polyphosphonic acids contain more than 2 phosphonic acid groups and are preferably represented by the following formula (3):

Y[P(O)(OH)₂]ₙ (3)

where n represents an integer greater than 2 and Y represents a straight-chain or branched, saturated or unsaturated n-valent hydrocarbon group preferably with 1-18, more preferably 2-12 and yet more preferably 3-6 carbon atoms. Y can comprise 1-4, preferably 1 or 2 carbon-carbon double bonds. Preferably, n is an integer value between 3 and 6 and more preferably 3 or 4.

Y is preferably obtained from the group R of formula (1), in that by abstraction of n−1 H atoms from n−1 carbon atoms, n−1 further binding sites are created for n−1 phosphonic acid groups. The abstraction of one or more H atoms can also take place at one of the above named C-containing substituents of the group R. Furthermore, one or more C atoms can be replaced with heteroatoms. The same applies as stated for formula (1).

The phosphonic acid groups can (in the event that n=3 or 4) bond with the same carbon atom of the Y group or they can (in the event of 3, 4, 5 or 6 phosphonic acid groups) each bond with different carbon atoms. 2 or 3 phosphonic acid groups can also bond with a carbon atom, and any other phosphonic acid groups present can bond with another carbon atom or with a plurality of other carbon atoms.

Examples of a polyphosphonic acid include aminotri(methylene phosphonic acid), diethyltriaminepenta(methylene phosphonic acid), ethylenediaminetetra(methylene phosphonic acid) and nitrilo-tri-(methylene phosphonic acid).

The phosphoric acid monoesters are compounds which can preferably be represented by the following general formula (4):

R—O—PO(OH)₂ (4)

R has the same meaning here as defined above for the organic monophosphonic acids of formula (1).

Diphosphoric acid monoesters or polyphosphoric acid monoesters can also be used and these are preferably represented by the following formula (5):

Y[O—PO(OH)₂]₁ (5)

Here, 1 is an integer value from 2 to 5, preferably 2 or 3. If 1 is 2, Y has the same meaning as defined for X in the organic diphosphonic acids of formula (2). If 1 is greater than 2, Y has the same meaning as above for the polyphosphonic acids of formula (3). The phosphoric acid monoester groups can be bonded to the same or different carbon atoms of Y.

Sulphur-containing acids such as sulphuric acid, sulphurous acid, sulphonic acid, organic sulphuric acid monoesters with at least two sulphuric acid monoester groups or organic sulphonic acids with at least two sulphonic acid ester groups can also be used.

The sulphuric acid monoesters with at least two sulphuric acid monoester groups can preferably be represented by the following formula (6):

X″(O—SO₂—OH)ₑ (6)

where e represents an integer value of at least 2, preferably 2-5 and more preferably 2 or 3.

If e is 2, X″ has the same meaning as X in the case of organic diphosphonic acids of formula (2). If e is greater than 2, X″ has the same meaning as Y in formula (3).

The sulphuric acid monoester groups can each bond independently with the same or different carbon atoms of X, wherein 2 or 3 sulphuric acid monoester groups can bond with the same carbon atom.

The sulphonic acid monoester with at least two sulphonic acid monoester groups can preferably be represented by the following formula (7):

X′″(O—SO—OH)_{f} (7)

where f represents an integer value of at least 2, preferably 2-5 and more preferably 2 or 3.

If f is 2, X′″ has the same meaning as X in the case of the organic diphosphonic acids of formula (2). If f is greater than 2, X′″ has the same meaning as Y in formula (3).

Sulphonic acid monoester groups can each bond independently with the same or different carbon atoms of X, wherein 2 or 3 sulphonic acid monoester groups can bond with the same carbon atom.

A particularly preferred acid is phosphoric acid.

Apart from the combinations of polybasic acid and nitrogen-containing base (i) or a suitable salt (ii) described above, betaines (iii), that is, inner salts can also be used. The term “betaine” denotes compounds which comprise within the molecule a group with a positive charge (such as an ammonium or pyridinium group) and a group with a negative charge (such as a (partially) deprotonated phosphoric acid monoester group). Such compounds can be represented by the following formula (8):

(B)_{g}-Z-(S)ₕ (8)

B represents a nitrogen-containing basic group, Z represents an organic linking group and S is a polybasic acid group. g and h denote the number of these groups and are preferably selected so that the betaine is charge-neutral. Otherwise, the betaine is associated with the required number of positively or negatively charged counterions.

These betaines comprise one or more nitrogen-containing basic groups B (such as a primary, secondary or tertiary amino group, an imino group, a pyridinyl, piperidinyl, piperazinyl, pyrrolidinyl, pyrazolyl or morpholinyl group), so that g is preferably 1-6, more preferably 1-4 and most preferably 1 or 2). At least one of these is present in a protonated form, that is, it carries a positive charge.

These betaines also contain in the molecule one or more polybasic acid groups (such as a phosphoric acid monoester group, a phosphonic acid group, a sulphuric acid monoester group and a sulphonic acid monoester group) within a molecule, that is h is preferably 1-6, more preferably 1-4 and most preferably 1 or 2. At least one of the polybasic acid groups is present in a (partially) dissociated form, that is it carries a negative charge. These are bound to one another via an organic linking group Z. In the case of a betaine, the expression “polybasic acid group” also covers groups which are present in their partially or completely deprotonated form and in this form do not necessarily have a plurality of protons (e.g. a —O—P(OH)(O)⁻ group).

The organic linking group Z is not particularly restricted, but preferably comprises 1-45, more preferably 4-30, even more preferably 5-22 and most preferably 6-18 carbon atoms. The binding group can be a straight-chain or branched alkyl, alkenyl or alkinyl group, which itself can undergo substitution with one or more alkyl, alkenyl, alkinyl, cycloalkyl, cycloalkylene, heterocycloalkyl, aryl or heteroaryl group(s). Furthermore, the organic linking group can itself be a cycloalkyl, cycloalkylene, heterocycloalkyl, aryl or heteroaryl group, which in turn can undergo substitution with one or more alkyl, alkenyl, alkinyl, cycloalkyl, cycloalkylene, heterocycloalkyl, aryl or heteroaryl group(s). The base and acid groups can also be bound within the molecule via heteroatoms (such as via an ether or sulphide linkage) and the linking group can have one or more substituents (such as F, Cl, Br, I, cyano, carboxy or hydroxyl).

The quantity ratio of nitrogen-containing base(s) to polybasic acid(s) in the acid/base combination (i) or (ii) is not particularly restricted. However, according to the invention, it is preferred that the quantity ratio is such that a salt of the nitrogen-containing base and the polybasic acid(s) can be formed. The molar ratio base/acid is therefore preferably greater than 0.8 and more preferably greater than 0.95. Even a relatively large excess of base does not interfere with the surface treatment, although it can lead to solubility problems in some solvents. The molar base/acid ratio should therefore preferably lie in the range of 1-6, more preferably 1-4 and even more preferably 1.2-2.5. A ratio in the region of 1.2-2 is still more preferable.

The quantity of acid/base combination used is also not particularly restricted. Since the quantity required for surface modification is dependent on factors which are difficult to determine such as the surface of the nanoparticles or the degree of surface coating of dispersion-promoting molecules on the surface of the nanoparticles, it is difficult to state a generally applicable required quantity of acid/base combination. However, an excess of the acid/base combination does not interfere with the surface modification. When in doubt, an excess of the acid/base combination should therefore be used. For economic reasons, however, it is desirable to keep the quantity of the acid/base combination used as low as possible. As a starting point for determining the minimum quantity of acid/base combination, the quantity needed to produce a monolayer of acid/base on the surface of the nanoparticles can be stipulated. In general, it is sufficient to use at least 2 ml of a 1 mol/l solution of base or acid (i.e. at least 2×10⁻³ mol of base and 2×10⁻³ mol of acid) per 1 g of nanoparticles, wherein the total volume is preferably in the range of 5 ml to 25 ml (i.e. 3 ml to 23 ml solvent and 2 ml of the 1 mol/l solution of base or acid per 1 g of nanoparticles). However, the use of a solvent is not absolutely necessary if the acid/base combination is itself liquid under the treatment conditions.

From among the nitrogen-containing bases, in particular the aliphatic, alicyclic and aromatic bases and the polybasic acids, preferably those which form a salt during the surface treatment are selected. This means that the alkalinity of at beast one of the bases used should be greater than the acidity of the first dissociation step of at least one of the polybasic acids used (pK_{B} (base)≦pK_{S1} (acid)). This is advantageous particularly if the free acid or base is insoluble in the solvent used, since in some cases, the solubility of the acid/base combination can be increased thereby.

The sequence of addition of the individual components is not subject to any particular restrictions. This means that base, acid, nanoparticles and possibly the solvent can be added in any arbitrary sequence. However, it is preferable to place the nanoparticles in a solvent and then to add the acid/base combination ((i), (ii) or (iii)) thereto, possibly in a solvent. Naturally, the nanoparticles (possibly in a solvent) can also be added to the acid/base combination (possibly in a solvent). Preferably, base and acid and/or their salts are thereby brought together with the nanoparticles (possibly in a solvent) simultaneously and not successively.

In the case of variant (ii), that is in the event that the acid/base combination is added as a salt, the salt can also be produced and isolated, for example by removal of the solvent or fractionated crystallisation, before the bringing together with the nanoparticles. The term “salt” as used here covers both salts of polybasic acids and bases in the ratio of 1:1, i.e. only one proton of the polybasic acid is abstracted by the base, as well as salts in the ratio base/acid of 2:1 or depending on the number of protons of the polybasic acid, 3:1, 4:1, 5:1, etc. An example of a salt in the ratio of 1:1 is (N(n-C₆H₁₃)₃H)⁺(H₂PO₄)⁻. An example of a salt in the ratio of 1:2 is [(N(n-C₆H₁₃)₃H)⁺₂(HPO₄)]²⁻. In the event that the nitrogen-containing base contains more than one basic nitrogen atom, salts can also be formed in the acid/base ratio of 1:2, 2:2, 2:3, etc. The same that applies for variant (i), applies accordingly for variant (ii) and (iii), provided this does not contradict the required salt formation.

The inventive surface treatment method is preferably carried out in a solvent. As for the quantity of the acid/base combination, the quantity of the solvent is also not particularly restricted. If the acid/base combination is a liquid (e.g. in the case of a large excess of acid or base, and given that the component present in excess under the treatment conditions is a liquid) no solvent need be used. In general, a solvent is used in quantities such that the liquid used in the inventive surface treatment method has a concentration of base and acid each of 0.005 mol/1-1 mol/l, preferably 0.01 mol/1-0.8 mol/l and more preferably 0.1 mol/1-0.5 mol/l.

The type of solvent is also not particularly restricted. Commonly used organic solvents can be used. Examples are aromatic hydrocarbons such as benzene, toluene and xylene, halogenated solvents such as chloroform, dichloromethane, tetrachloroethane and tetrachloromethane, ethers such as dimethyl ether, diethyl ether, diisopropyl ether, diphenyl ether and tetrahydrofuran (THF), ketones such as methylethyl ketone (MEK) and diethyl ketone, alcohols such as methanol, ethanol, propanol and iso-propanol, esters such as butyl acetate and ethyl acetate and other common solvents such as acetonitrile. These solvents can be used alone or in a mixture of 2 or more solvents. In this context, protic or aprotic solvents can be used, wherein aprotic solvents are preferred. Preferred solvents have a boiling point at normal pressure of 30° C. to 180° C., more preferably 60° C. to 160° C., and yet more preferably 90° C. to 150° C.

Preferably, the solvent used in the inventive surface treatment method is the solvent which is to be used in the final application of the nanoparticle dispersion, or it is similar thereto with regard to polarity. It can thereby be ensured that a good re-dispersion is achieved in the final application.

As described above, the inventive surface treatment method for nanoparticles is carried out by treating the nanoparticles with a combination of a nitrogen-containing base and a polybasic acid, preferably in a solvent. With regard to the conditions during the treatment, no explicit restrictions exist, but it is advantageous to carry out the treatment at a temperature in the range between room temperature and the boiling point of any solvent that is used, at normal pressure. In order to increase the reaction rate, the inventive method for the surface treatment of nanoparticles is preferably carried out at a temperature above room temperature, preferably in the range 30° C.-100° C., more preferably 60° C. to 90° C.

If one or more high boiling solvents (boiling point at normal pressure above 100° C.) are used, it may be advantageous to carry out the treatment at reduced pressure and raised temperature. In this case, the solvent can be evaporated at reduced pressure immediately after the treatment with the acid/base combination, in order to isolate the nanoparticles treated according to the invention. However, separation of the treated nanoparticles from the treatment solution can also be carried out with other methods known to persons skilled in the art, such as ultrafiltration or centrifuging.

it is also preferable that the liquid or dispersion (nanoparticles, acid/base combination and possibly solvent) used in the inventive method is essentially free from dissolved metal ions, that is, the concentration of dissolved metal ions is preferably less than 0.01 mol/l, and more preferably less than 0.001 mol/l.

The inventive surface treatment method is applicable to any inorganic nanoparticles which have reduced dispersibility following their synthesis and isolation. Preferably, they are inorganic metal salt nanoparticles, which have a fully or mainly crystalline structure. The nanoparticles can be doped and, in particular, phosphorescent or fluorescent.

The nanoparticles are preferably selected from the group of phosphates, halophosphates, arsenates, sulphates, borates, aluminates, gallates, silicates, germinates, oxides, vanadates, niobates, tantalates, wolframates, molybdates, alkali halogenates, halides (e.g. fluorides, chlorides, iodides), nitrides, sulphides, selenides, sulphoselenides and oxysulphides.

The inventive method can therefore be applied to phosphate-containing and non-phosphate-containing nanoparticles. The inventive method is further applicable to semiconducting as well as, preferably, non-semiconducting nanoparticles, wherein the latter can be chosen from among the substance classes set out above.

Preferably, the inventive method is applied to the following nanoparticles:

1) Hydrothermally synthesised nanoparticles
2) Doped or non-doped nanoparticles according to the teaching of WO 02/20696 A1, which are selected from the above substance classes. They can be obtained according to a method wherein anion and cation sources are allowed to react while being heated in a synthesis mixture which comprises a component controlling the crystal growth of the nanoparticles, in particular an organophosphorus compound (e.g. those which are disclosed in claim 3 of the WO publication) or a monoalkylamine, in particular dodecyamine, or a dialkyamine, in particular bis-(ethylhexyl)-amine and possibly a further solvent. Nanoparticles which are subjected to the inventive surface treatment method are disclosed in the examples of WO 02/20696 A1 and claims 32 to 34 of that document.
3) Nanoparticles according to the teaching of WO 2004/046035 with a crystal lattice or, in the case of doping, a host lattice essentially consisting of Z-sulphate (Z=magnesium, calcium, strontium or barium), obtainable through controlled crystal growth in a non-aqueous solvent with coordinating properties, in particular a polyalcohol or DMSO, wherein the nanoparticles have a mean particle size of 1 nm to 50 nm and have the property that they are dispersible in water.
4) Nanoparticles according to the teaching of WO 2005/105933, which can be obtained through a method for producing possibly doped nanoparticulate metal sulphate nanoparticles, wherein the metal is selected from among polyvalent and monovalent transition metals and the method comprises at least the following steps:
a) heating a reaction mixture comprising
a polar organic solvent which comprises at least two hydroxyl groups or a polar solvent which comprises at least one sulphoxide group,
a source of a polyvalent metal or a monovalent transition metal, a sulphate source and possibly a dopant metal source, and
a base, selected from among the following:
   bases with an aromatic nitrogen-containing heterocyclic compound apart from imidazole
   bases with an aliphatic nitrogen-containing heterocyclic compound,
   aliphatic hydroxyl-substituted amines
   aliphatic polyamines
   aromatic amines
   ammonia and ammonia-releasing compounds, and
   metal hydroxides
      5) Nanoparticles according to WO2004/096714, which can be obtained with a method for producing nanoparticles which comprise a metal-(III)-vanadate, wherein the method comprises a reaction of a reactive vanadate source, which is also soluble or dispersible in a reaction medium, with a reactive metal-(III) salt which is soluble or dispersible in the reaction medium with heating, characterised in that the reaction medium contains water and at least one polyalcohol in a volume ratio of from 20/80 to 90/10.
      6) Nanoparticles with a size of preferably less than 25 nm, which completely or partially comprise titanium-containing oxide particles which are obtainable with a method which comprises the reaction of a hydrolysable halide-containing titanium compound with water in a reaction mixture which contains at least one polyalcohol. This method is described in the copending application PCT/EP2004/012376.
      7) Luminescent nanoparticles according to EP 1 473 347 A1 which comprise a core made from a first metal salt or oxide and a shell made from a second metal salt or oxide, and have non-semiconducting properties, wherein preferably the salt of the core and the shell have the same anion which is preferably selected from among the phosphates, sulphates or fluorides.
      8) Luminescent nanoparticles according to EP 1 473 348 A1, which comprise a core made from a luminescent metal salt which is selected from among the phosphates, sulphates or fluorides, and a shell made from a metal salt or oxide which is able to prevent or reduce the energy transfer from the core, following its electronic excitation, to the surface of the nanoparticles.

It was surprisingly found, according to the invention, that no particular matching is necessary between the acid/base combination to be used and the chemical composition of the nanoparticles. However, in one embodiment of the invention a polybasic acid which corresponds to the anion that builds up the nanoparticle to be treated (in core/shell particles, the anion which builds up the shell) is used for the acid/base combination. It is assumed that a particularly good affinity of the acid/base combination for the surface of the nanoparticles can thereby be achieved. For example, in the case of the surface treatment of nanoparticles which have phosphate groups on their surface, phosphoric acid can be used as the polybasic acid for the acid/base combination. Correspondingly, in the case of nanoparticles which have been produced by the use of borates, boric acid can be used. Similarly, in the case of the use of metal sulphates during nanoparticle synthesis in the inventive surface treatment method, sulphuric acid can be used.

In another embodiment, the acid/base combination does not comprise any components (polybasic acids, anions of these polybasic acids and/or nitrogen-containing bases) which were used in the synthesis of the nanoparticles. In this event, for example, in the case of sulphate nanoparticles, an acid/base combination is used which contains no sulphuric acid or sulphate ions (example: the use of phosphoric acid as a polybasic acid). Similarly, in the case of phosphate nanoparticles, an acid/base combination can be used which does not contain any phosphoric acid or phosphate (example: use of sulphuric acid as the polybasic acid).

The inventive surface treatment method is also carried out under conditions which do not permit any particle growth. Preferably, therefore, essentially no (especially dissolved) metal ions are present, and in particular none which are also present in the nanoparticles (as cations).

The inventive surface treatment method will now be described with examples. However, these examples should not be interpreted as limiting the scope of the invention.

### EXAMPLES

### Solution A

9.8 g (100 mmol) anhydrous phosphoric acid H₃PO₄ is added to 40 ml diphenyl ether and then 50 ml (150 mmol) trihexylamine is added. The mixture is placed under negative pressure on a rotary evaporator and slowly heated to 80° C. As soon as a clear solution is obtained which no longer gives off water, the heating is stopped. Following cooling, the solution is made up to 100 ml with diphenyl ether and stored in a closed vessel.

### Solution B

9.8 g (100 mmol) anhydrous phosphoric acid H₃PO₄ is added to 80 ml diphenyl ether and then 95 ml (150 mmol) tridodecylamine is added. The mixture is placed under negative pressure on a rotary evaporator and slowly heated to 80° C. As soon as a clear solution is obtained which no longer gives off water, the heating is stopped. Following cooling, the solution is made up to 200 ml with diphenyl ether and stored in a closed vessel.

### Solution C

9.8 g (50 mmol) anhydrous pyrophosphoric acid H₄P₂O₇ is added to 40 ml diphenyl ether and then 50 ml (150 mmol) trihexylamine is added. The mixture is placed under negative pressure on a rotary evaporator and slowly heated to 80° C. As soon as a clear solution is obtained which no longer gives off water, the heating is stopped. Following cooling, the solution is made up to 100 ml with diphenyl ether and stored in a closed vessel.

### Solution D

15.8 g (100 mmol) anhydrous phenylphosphonic acid C₆H₇PO₃ is added to 40 ml diphenyl ether and then 50 ml (150 mmol) trihexylamine is added. The mixture is placed under negative pressure on a rotary evaporator and slowly heated to 80° C. As soon as a clear solution is obtained which no longer gives off water, the heating is stopped. Following cooling, the solution is made up to 100 ml with diphenyl ether and stored in a closed vessel.

### Solution E

An aqueous solution with 10.3 g (50 mmol) 1-hydroxyethane-1,1-diphosphonic acid C₂H₈P₂O₇ is added to 40 ml diphenyl ether and then 50 ml (150 mmol) trihexylamine is added. The mixture is placed under negative pressure on a rotary evaporator and initially heated to 50° C. until the majority of the water has distilled off, then it is slowly heated to 80° C. As soon as a clear solution is obtained which no longer gives off water, the heating is stopped. Following cooling, the solution is made up to 100 ml with diphenyl ether and stored in a closed vessel.

### Solution F

15 g (50 mmol) anhydrous amino-tri-(methylene phosphonic acid) C₃H₁₂P₃NO₉ is added to 30 ml diphenyl ether and then 50 ml (150 mmol) trihexylamine is added. The mixture is placed under negative pressure on a rotary evaporator and slowly heated to 80° C. As soon as a clear solution is obtained which no longer gives off water, the heating is stopped. Following cooling, the solution is made up to 100 ml with diphenyl ether and stored in a closed vessel.

### Solution G

22 g (50 mmol) anhydrous ethylenediamine-tetra-(methylphosphonic acid) C₆H₂₀P₄N₂O₁₂ is added to 80 ml diphenyl ether and then 67 ml (200 mmol) trihexylamine is added. The mixture is placed under negative pressure on a rotary evaporator and slowly heated to 80° C. As soon as a clear solution is obtained which no longer gives off water, the heating is stopped. Following cooling, the solution is made up to 200 ml with diphenyl ether and stored in a closed vessel.

### Solution H

14 g (50 mmol) benzene-1-3-disulphonic acid disodium salt C₆H₄S₂O₆Na₂ is dissolved in 100 ml water and then slowly passed through an ion exchange column filled with Dowex 50 (H-form). The solution of free benzene-1,3-disulphonic acid thus obtained then has 50 ml diphenyl ether and 33 ml (100 mmol) trihexylamine added to it. The mixture is placed under negative pressure on a rotary evaporator and initially heated to 50° C. until the majority of the water has distilled off. It is then slowly heated to 80° C. As soon as a clear solution is obtained which no longer gives off water, the heating is stopped. Following cooling, the solution is made up to 100 ml with diphenyl ether and stored in a closed vessel.

### 1) LaPO₄:Eu-Nanoparticles

1.0 g LaPO₄:Eu nanoparticles made according to a method described in WO 02/20696 A1 is added to 20 ml diphenyl ether and 2 ml of solution A and heated at 20 mbar to 80° C., until a clear solution is obtained.

### 2) CePO₄:Tb-Nanoparticles

1.0 g CePO₄:Tb nanoparticles made according to a method described in WO 02/20696 A1 is added to 20 ml diphenyl ether and 4 ml of solution B and heated at 20 mbar to 80° C., until a clear solution is obtained.

### 3) LaPO₄—Ce,Tb/LaPO₄-Core/Shell-Nanoparticles

1.0 g LaPO₄:Ce,Tb/LaPO₄-core/shell-nanoparticles made according to a method described in “K. Kömpe, H. Borchert, J. Storz, A. Lobo, S. Adams, T. Möller, M. Haase (2003) Green-Emitting CePO₄:Tb/LaPO₄ Core/Shell Nanoparticles with 70% Photoluminescence Quantum Yield. Angew. Chem. Int. Ed. 42: 5513; Angew. Chem. 115: 5672)” is added to 20 ml diphenyl ether and 2 ml solution A and then heated at 20 mbar to 80° C., until a clear solution is obtained.

### 4) LaPO₄:Ce,Tb/LaPO₄-Core/Shell-Nanoparticles

1.0 g LaPO₄:Ce,Tb/LaPO₄-core/shell-nanoparticles made according to a method described in “K. Kömpe, H. Borchert, J. Storz, A. Lobo, S. Adams, T. Möller, M. Haase (2003) Green-Emitting CePO₄:Tb/LaPO₄ Core/Shell Nanoparticles with 70% Photoluminescence Quantum Yield. Angew. Chem. Int. Ed. 42: 5513; Angew. Chem. 115: 5672)” is added to 20 ml diphenyl ether and 2 ml solution C and then heated at 20 mbar to 80° C., until a clear solution is obtained.

### 5) LaPO₄:Ce,Tb/LaPO₄-Core/Shell-Nanoparticles

1.0 g LaPO₄:Ce,Tb/LaPO₄-core/shell-nanoparticles made according to a method described in “K. Kömpe, H. Borchert, J. Storz, A. Lobo, S. Adams, T. Möller, M. Haase (2003) Green-Emitting CePO₄:Tb/LaPO₄ Core/Shell Nanoparticies with 70% Photoluminescence Quantum Yield. Angew. Chem. Int. Ed. 42: 5513; Angew. Chem. 115: 5672)” is added to 20 ml diphenyl ether and 2 ml solution D and then heated at 20 mbar to 80° C., until a clear solution is obtained.

### 6) LaPO₄:Ce,Nd/LaPO₄-Core/Shell-Nanoparticles

1.0 g LaPO₄:Ce,Nd/LaPO₄-core/shell-nanoparticles made according to a method described in “K. Kömpe, H. Borchert, J. Storz, A. Lobo, S. Adams, T. Möller, M. Haase (2003) Green-Emitting CePO₄:Tb/LaPO₄ Core/Shell Nanoparticles with 70% Photoluminescence Quantum Yield. Angew. Chem. Int. Ed. 42: 5513; Angew. Chem. 115: 5672)” is added to 19 ml chloroform and 1 ml solution A and stirred over night, until a clear solution is obtained.

### 7) YVO₄:Eu-Nanoparticles

0.75 g YVO₄:Eu-nanoparticles made according to a method described in WO 2004/096714 is added to 20 ml diphenyl ether and 2 ml of solution A and heated at 20 mbar to 80° C., until a clear solution is obtained.

### 8) GdP₁₋ₓVₓO₄:Eu-Nanoparticles

0.75 g GdP₁₋ₓVₓO₄:Eu-nanoparticles made according to a method described in WO 2004/096714 is added to 20 ml diphenyl ether and 2 ml of solution A and heated at 20 mbar to 80° C., until a clear solution is obtained.

### 9) YP₁₋ₓVₓO₄:Eu-Nanoparticles

0.75 g YP₁₋ₓVₓO₄:Eu-nanoparticles made according to a method described in WO 2004/096714 is added to 20 ml diphenyl ether and 2 ml of solution B and heated at 20 mbar to 80° C., until a clear solution is obtained.

### 10) NaYF₄:Yb,Er-Nanoparticles

1.0 g NaYF₄:Yb,Er-nanoparticles made according to a method described in PCT/DE2000/003130 is added to 20 ml diphenyl ether and 2 ml of solution C and heated at 20 mbar to 80° C., until a clear solution is obtained.

### 11) TiO₂-Nanoparticles in Butyl Acetate

1.0 g TiO₂-nanoparticles made according to a method described in PCT/EP2004/012376 is added to 50 ml methanol and 3 ml solution A and heated under normal pressure to 60° C., until a clear solution is obtained. The solution is mixed with 50 ml butyl acetate and the methanol is carefully distilled off.

1. Surface treatment method for improving the dispersibility of nanoparticles which have been isolated following the synthesis step and possibly, following isolation, have been subjected to one or more washing steps, wherein the method comprises treatment of the nanoparticles with
(i) one or more organic nitrogen-containing bases and one or more polybasic acids, or
(ii) a salt from one or more organic nitrogen-containing bases and one or more polybasic acids, or
(iii) a betaine which comprises within the molecule one or more nitrogen-containing basic groups and one or more polybasic acid groups.

2. Surface treatment method according to claim 1, wherein in the treatment with (i) the base and the acid or with (ii) the salt thereof or (iii) the betaine, a solvent is used.

3. Surface treatment method according to claim 1, wherein the treatment temperature lies in the range of 30° C. to 100° C.

4. Surface treatment method according to claim 1, wherein the molar ratio of base to acid (base/acid) in case (i) or (ii) or of the basic group/polybasic acid group in case (iii) lies in the range of 1 to 5.

5. Surface treatment method according to claim 1, wherein the molar ratio of base to acid (base/acid) in case (i) or (ii) or of the basic group/polybasic acid group in case (iii) lies in the range of 1 to 2.

6. Surface treatment method according to claim 1, case (i) or (ii), wherein the nitrogen-containing base contains in the range of 2 to 30 carbon atoms.

7. Surface treatment method according to claim 6, case (i) or (ii), wherein the base is a primary, secondary or tertiary amine according to the formula NH₂R, NHRR′ or NRR′R″, wherein R, R′ and R″ denote organic hydrocarbon groups which may possibly undergo substitution and each contain in the range of 3 to 14 carbon atoms.

8. Surface treatment method according to claim 1, case (i) or (ii), wherein the base is an aromatic nitrogen-containing base with in the range of 3 to 30 carbon atoms.

9. Surface treatment method according to claim 1, case (i) or (ii), wherein the base is an alicyclic nitrogen-containing base with in the range of 2 to 30 carbon atoms.

10. Surface treatment method according to claim 1, wherein the polybasic acid in case (i) or (ii) or the polybasic acid group in case (iii) is selected from among phosphorus-containing and sulphur-containing acids or acid groups.

11. Surface treatment method according to claim 10, case (i) or (ii), wherein the acid is selected from among phosphoric acid, diphosphoric acid, polyphosphoric acids, organic phosphonic acids, organic diphosphonic acids, organic polyphosphonic acids, phosphoric acid monoesters, phosphonic acid monoesters with at least two phosphonic acid ester groups, sulphuric acid, sulphurous acid, sulphonic acid, sulphuric acid monoesters with at least two sulphuric acid monoester groups and sulphonic acid monoesters with at least two sulphonic acid monoester groups.

12. Surface treatment method according to claim 10, case (i) or (ii), wherein the polybasic acid comprises one or more organic groups which possibly comprise one or more hydroxyl, amino, or carboxylic acid or cyano functional groups.

13. Surface treatment method according to claim 1, wherein at least one of the bases used in case (i) or (ii) or one of the nitrogen-containing basic groups present in case (iii) has an alkalinity in order to remove a proton from at least one of the acids used (pK_{B} (base)≦pK_{S1} (acid)).

14. Surface treatment method according to claim 1, wherein essentially no metal ions are present during the treatment.

15. Nanoparticles which can be obtained with a surface treatment method according to claim 1.

16. Nanoparticle dispersion comprising a solvent and nanoparticles according to claim 15.

17. (canceled)
